(19) United States
(12) Patent Application Publication
(10) Pub. No.: US 2003/0101217 A1
(43) Pub. Date: May 29, 2003

(54) Communication network system

(76) Inventors: Toshihiro Aiyoshi, Ome-shi (JP); Ryo Hatano, Kodaira-shi (JP); Kenichi Tonouchi, Ome-shi (JP); Takero Kobayashi, Ome-shi (JP); Yasuhiro Ishibashi, Ome-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/235,956

(22) Filed: Sep. 6, 2002

(30) Foreign Application Priority Data
Nov. 26, 2001 (JP) 2001-359606

(51) Int. Cl. G06F 15/16

(52) U.S. Cl. 709/203

(57) ABSTRACT

This invention provides a communication network system capable of obtaining setting information used in a network application program. This invention acquires setting information by using a protocol in which the option field of DHCP (Dynamic Host Configuration Protocol) contains a first field of 2 bytes or more which stores an identification number representing the type of setting information, and a second field which stores the setting information.

### CROSS-REFERENCE TO RELATED APPLICATIONS

This application is based upon and claims the benefit of priority from the prior Japanese Patent Application No. 2001-359606, filed Nov. 26, 2001, the entire contents of which are incorporated herein by reference.

### BACKGROUND OF THE INVENTION

1. Field of the Invention

The present invention relates to a communication system and, more particularly, to a communication system using a protocol obtained by extending DHCP (Dynamic Host Configuration Protocol) for transferring setting information to a network terminal connected to a TCP/IP network.

2. Description of the Related Art

DHCP (Dynamic Host Configuration Protocol) has been used to transfer setting information to a network terminal connected to a TCP/IP network.

DHCP is a protocol which defines a scheme of extending the message format of a BOOTP protocol and transferring setting information such as a network address to a network terminal. The BOOTP protocol is described in Croft, B., and J. Gilmor, “Bootstrap Protocol (BOOTP)”, RFC 951, Stanford and SUN Microsystems, September 1985.

In IETF (Internet Engineering Task Force) as a consortium which is promoting standardization of Internet techniques, DHCP is defined by a document numbered RFC (Requests For Comment) 2131. The DHCP function will be described briefly.

DHCP adopts a client-server system. A DHCP server manages setting information such as a network address, whereas a network terminal as a DHCP client receives the setting information.

DHCP messages are exchanged as follows.

1. The DHCP client broadcasts a DHCPDISCOVER message to a local network.

2. If the DHCP server receives the DHCPDISCOVER message, the server sends back a DHCPOFFER message to the transmitting DHCP client. The DHCPOFFER message contains an “assigned IP address” and another setting information.

3. The DHCP client receives DHCPOFFER messages from one or more DHCP servers. The DHCP client confirms setting information contained in the DHCPOFFER messages, selects one of the DHCP servers, and broadcasts a DHCPREQUEST message containing the ID of the selected DHCP server. The DHCPREQUEST message can be assigned an option for requesting necessary setting information.

4. The DHCP server receives the DHCPREQUEST message. A DHCP server not designated by the server ID performs no processing. The DHCP server designated by the server ID sends back the requested setting information in a DHCPACK message. If the DHCP server cannot provide the requested setting information, the server sends back DHCPNAK.

5. If the DHCP client receives DHCPNAK, the client confirms the contained setting information, saves necessary information, and ends setting. If the DHCP client receives a DHCPNAK message, the client retries setting.

Details of DHCP messages are described in Droms, R., “Dynamic Host Configuration Protocol”, RFC 2131, March 1997.

A network terminal which has received setting information transferred by DHCP can be connected to a network by using the setting information.

DHCP is designed for a network terminal on a fixed LAN. When a network terminal is to be connected to another network, setting information necessary to use a network application is not always transferred. The user of the network terminal must manually change the settings of the network application.

No method exists to automatically acquire necessary setting information, and the user may not know information which should be set. If no acquisition means is provided because of the absence of a network manager, the user may not be able to use a network application.

DHCP is assigned only 256 figures for identifying the type of setting information, which is insufficient to transfer even setting information of a network application.

### BRIEF SUMMARY OF THE INVENTION

The present invention has been made in consideration of the above situation, and has as its object to provide a communication system capable of transferring setting information such that the user who carries a network terminal with him/her and tries to connect the network terminal to different networks can connect the network terminal to a network and utilize a network application.

To achieve the above object, according to a first aspect of the invention, there is provided a communication system comprising a server having a storage portion which stores setting information of a network application program running on a network terminal; and a client configured to communicate with the server via a network and outputs a setting information request for requesting the setting information to the server, wherein the setting information request contains a first field which stores an identification number representing a type of the setting information and a second field which stores the setting information, and the server sets, in the second field, setting information corresponding to the identification number contained in the first field of the setting information request from the client, and outputs the setting information set in the second field to the client.

To achieve the above object, according to a second aspect of the invention, there is provided a setting information acquisition method comprising outputting from a client to a server a setting information request complying with a predetermined protocol which requests setting information of a network application program running on a network terminal; outputting requested information from the server to the client in accordance with the predetermined protocol on the basis of the setting information request; and receiving by the client the requested setting information output from the server, wherein the predetermined protocol contains a first field which stores an identification number representing a type of setting information, and a second field which stores the setting information, and the server sets, in the second field, setting information corresponding to the identification number stored in the first field, and outputs the setting information set in the second field to the client by using the predetermined protocol.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a network environment using a CF protocol;

FIG. 2 is a view showing a state in which a CF client 4 is moved to a network 2 shown in FIG. 1;

FIG. 3 is a view showing a state in which the CF client 4 shown in FIG. 2 is connected to the network 2;

FIG. 4 is a table showing the description of each field in DHCP;

FIG. 5 is a view showing a structure of the option field of the CF protocol;

FIG. 6 is a view showing the structure of the DHCP option field;

FIG. 7 is a table showing the option code of the CF protocol;

FIG. 8 is a view showing an example of the option field of the CF protocol;

FIG. 9 is a view showing another example of the option field of the CF protocol;

FIG. 10 is a table showing options usable as sub code options of the CF protocol out of option codes of DHCP;

FIG. 11 is a table showing examples of the sub code of the CF protocol;

FIG. 12 is a table showing examples of the sub code of the CF protocol;

FIG. 13 is a block diagram showing the arrangement of CF servers 3a and 3b;

FIG. 14 is a table showing a setting information storage portion;

FIG. 15 is a table showing another setting information storage portion;

FIG. 16 is a block diagram showing the arrangement of the CF client 4;

FIG. 17 is a flow chart for explaining the operation of a wireless communication system according to an embodiment of the present invention; and

FIG. 18 is a flow chart for explaining the operation of the wireless communication system according to the embodiment of the present invention.

### DETAILED DESCRIPTION OF THE INVENTION

A wireless communication system according to a preferred embodiment of the present invention will be described below with reference to the several views of the accompanying drawing.

A protocol for transferring setting information used in the wireless communication system of the embodiment is prepared by extending the option field of DHCP. In the embodiment, this protocol will be called a ConfigFree (to be simply referred to as CF hereinafter) protocol. Similar to DHCP, setting information is transferred from a CF server to a CF client.

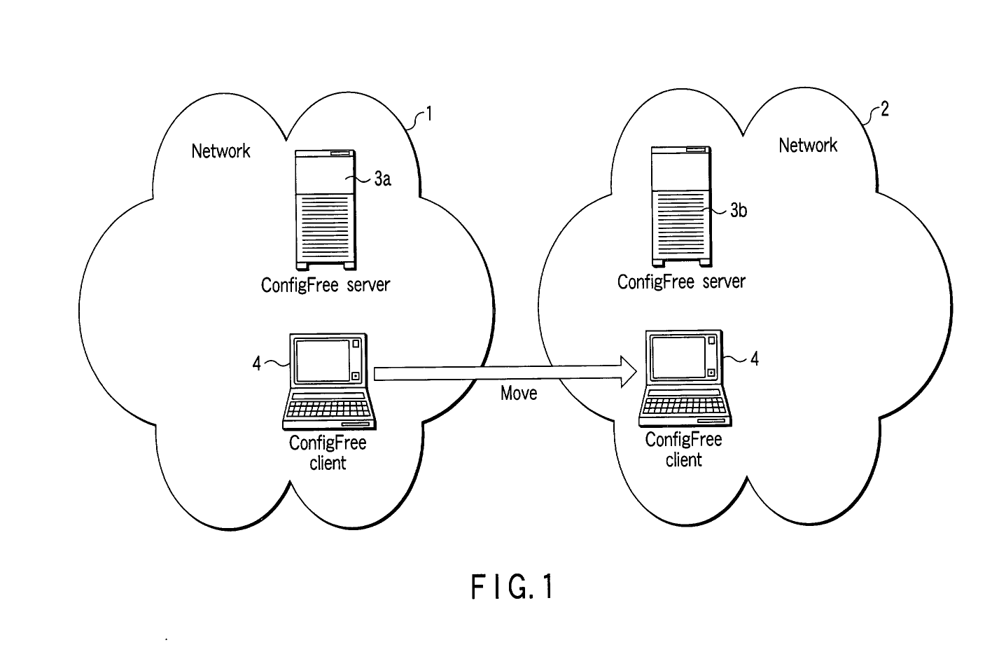

FIG. 1 is a view showing a network environment using the CF protocol. As shown in FIG. 1, a network 1 has a CF server 3a, and a network 2 has a CF server 3b.

The CF protocol is used when a CF client 4 is moved from the network 1 to the network 2 using different network settings.

The CF servers 3a and 3b manage and distribute setting information.

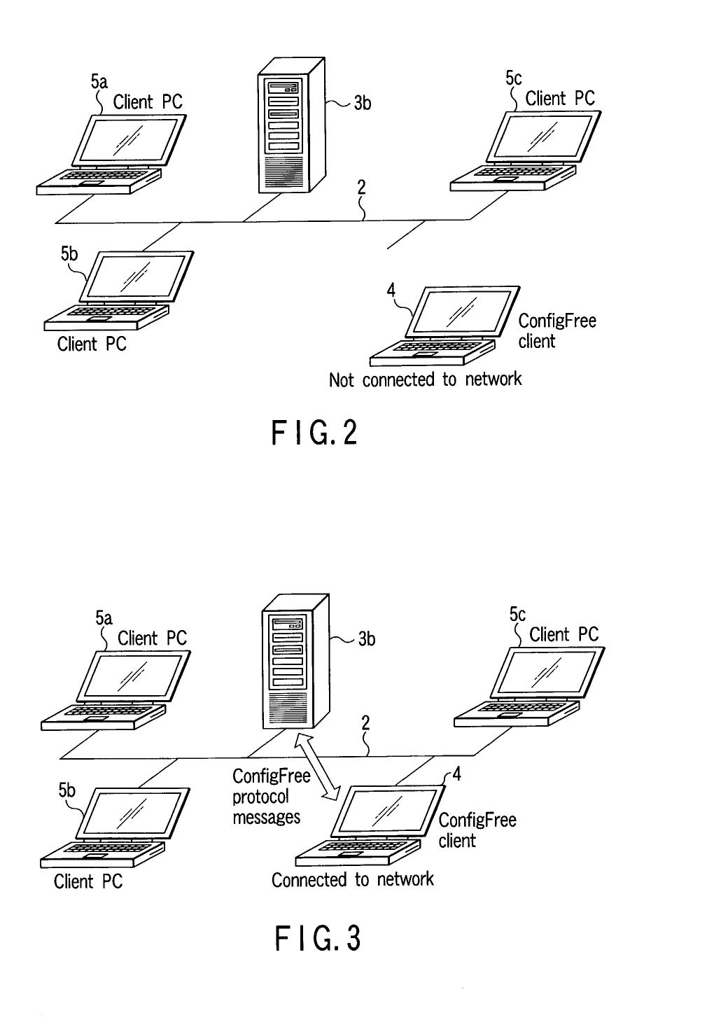

FIG. 2 is a view showing a case in which the CF client 4 is moved to the network 2 shown in FIG. 1. At this time, the CF client 4 holds setting information of the network 1 connected before movement. In FIG. 2, client PCs 5a to 5c are connected to the network 2.

FIG. 3 is a view showing a state in which the CF client 4 shown in FIG. 2 is connected to the network 2. In a conventional wireless communication system, a server and client exchange messages by the above-described procedures using DHCP, and information such as a network address is sent to the client. As a result, the client can be connected to a network to communicate data.

DHCP does not distribute, e.g., information of an HTTP proxy server. If the network 2 permits only a Web access via the HTTP proxy server, a Web browser running on a client cannot access the Web.

In practice, a local network in a company often employs an HTTP proxy server in terms of the security. To the contrary, a public space such as an airport lobby or Internet cafe where a network access point is provided rarely uses any HTTP proxy server. The above-described problem occurs at high possibility when a client is to be moved and connected to a plurality of networks.

The CF protocol according to the embodiment of the present invention can transfer even setting information used by a network application such as an HTTP proxy server or default homepage, country/region information, and time information, which are not transferred by the conventional DHCP. As far as an application on the network terminal side copes with the CF protocol, the network terminal user can immediately connect his/her network terminal to a network anywhere and use an application without any manual setting operation.

In the future, services which provide access points in public spaces will increase more and more. The CF protocol yields a prominent effect of eliminating resetting of a network application such as a Web browser every connection to a network outside the user home or on the move.

In FIGS. 2 and 3, the network is connected by wire, but may be connected wirelessly. The network is wireless at many access points in public spaces. User's connection operation is simpler for a wireless network than for a wired network because the user need not connect a network terminal and network cable.

A scheme or protocol of transferring setting information from a server to a client by the CF protocol will be explained.

The CF protocol is an extended protocol of DHCP in order to increase the affinity with an existing network protocol and facilitate packaging.

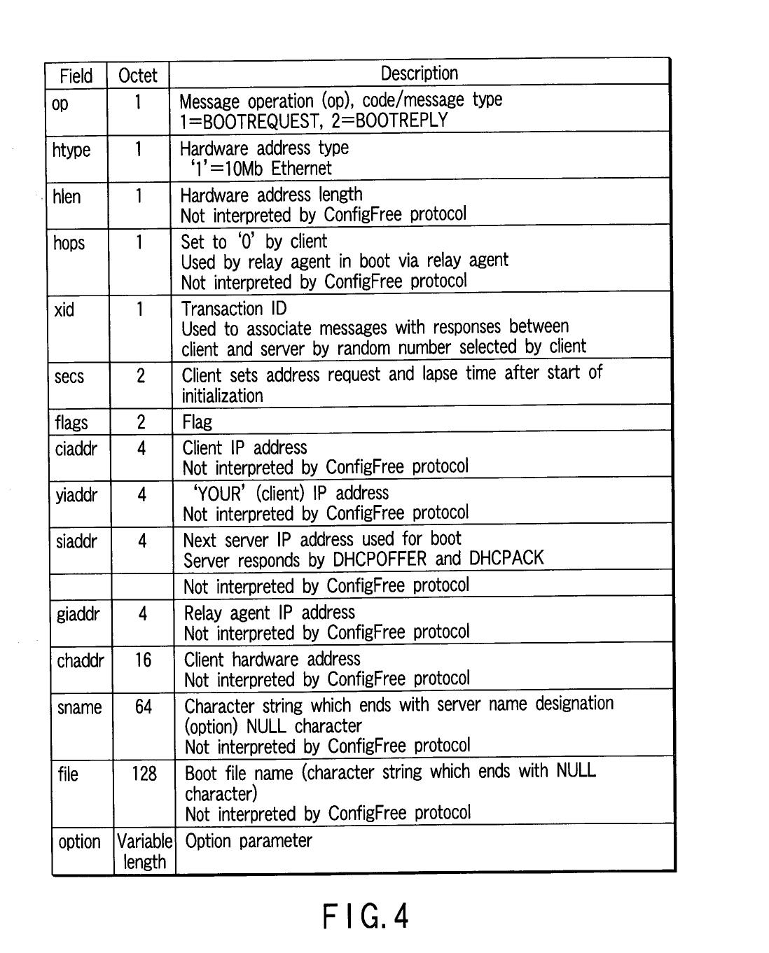

Hence, the message format of the CF protocol is the same as that of DHCP. Respective fields in the message are also the same as those of DHCP. Although the CF does not require some fields, these fields are received by a CF server or client but ignored without interpreting them. FIG. 4 shows the description of each field in addition to the presence/absence of interpretation.

The CF protocol uses UDP (User Datagram Protocol), similar to DHCP. UDP is a transport layer protocol in TCP/IP communication, and performs best-effort datagram orientated-communication (no recipient confirmation). For this purpose, a UDP port number must be designated. If the CF protocol is generally accepted as a DHCP extension, the same port number as that of DHCP will be used; otherwise, another port number will be used. This embodiment uses port 20001 though this port number does not change the operation of the CF protocol.

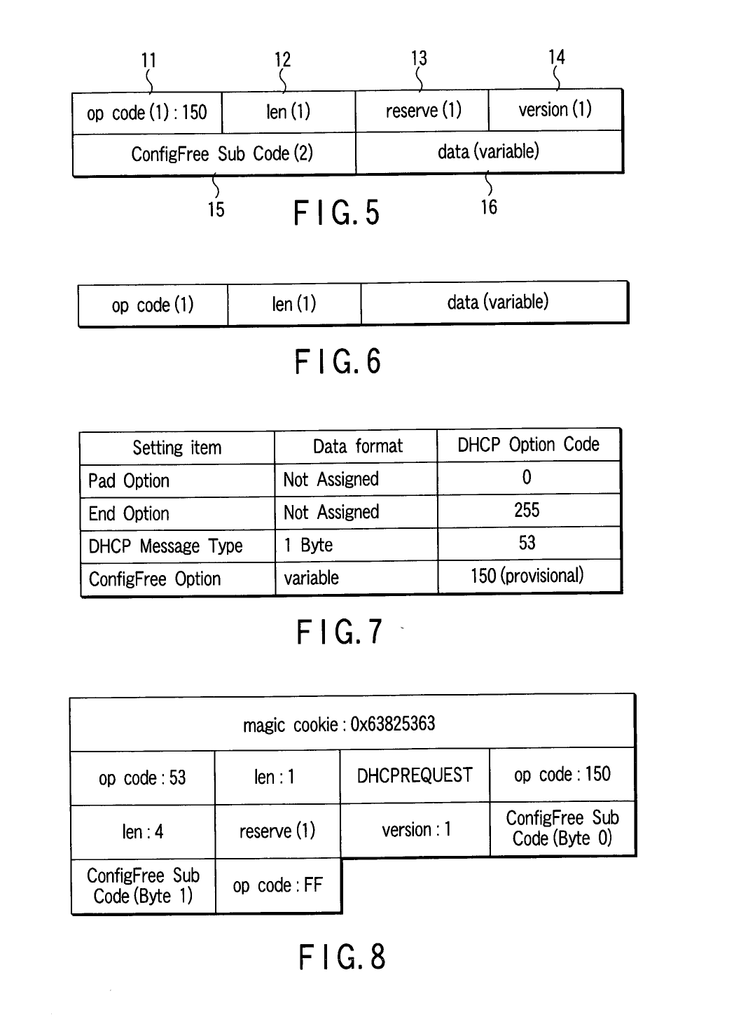

Setting information distributed by the CF protocol is contained in an option field. FIG. 5 shows a structure of the option field. A parenthesized figure represents a field size by the number of bytes. This structure is basically the same as that of DHCP, and is an extension of the data part of the DHCP option field. FIG. 6 shows the structure of the DHCP option field.

The structure in FIG. 5 will be explained.

An op code 11 represents an option code in DHCP. Details of the option code are described in Alexander S. and R. Droms, “DHC Options and BOOTP Vendor Extensions”, RFC 2132, March 1997 (to be referred to as RFC 2132 hereinafter).

The CF protocol uses only option codes shown in FIG. 7. Other option codes are ignored in the CF protocol. As for three, Pad Option, End Option, and DHCP Message Type, codes defined by DHCP are used.

Details of the three option codes are described in RFC 2132. As for CF Option, a code number is set when the CF protocol is generally accepted as an extension of DHCP.

This embodiment temporarily uses number 150 out of numbers 128 to 254 reserved for options unique to the network site in DHCP. Even if this value changes to another one, the effects of the present invention are not lost.

A len field 12 in the option field describes by the number of bytes the sum of the lengths of fields: reserve 13, version 14, CF Sub Code 15, and data 16 in FIG. 5.

The reserve field 13 describes version information of the CF protocol. As the version information format, upper 4 bits of the version field represent an integral part, and lower 4 bits represent a decimal part.

The CF Sub Code field 15 describes an identification number for identifying the type of setting information transferred by the CF. The identification number will be described later.

The data field 16 describes setting information of the type designated by CF Sub Code. The data field will be described later together with CF Sub Code.

Two examples of the option field of the message of the CF protocol will be explained.

The first example is a setting information request sent from a CF client to a CF server. FIG. 8 shows this example of the option field. A figure after the colon represents a set value.

“magic cookie” is set at first 4 bits of the option field, similar to DHCP.

Three bytes subsequent to magic cookie are an option representing the type of DHCP message. To request setting information by the CF, DHCPREQUEST (value: 3) is designated as the type.

Six bytes starting from the next op code: 150 are an option representing a CF sub code. An identification number representing the type of setting information to be requested is designated in the CF Sub Code field.

The last 1 byte with a value 0xFF is an End option representing the end of an effective option.

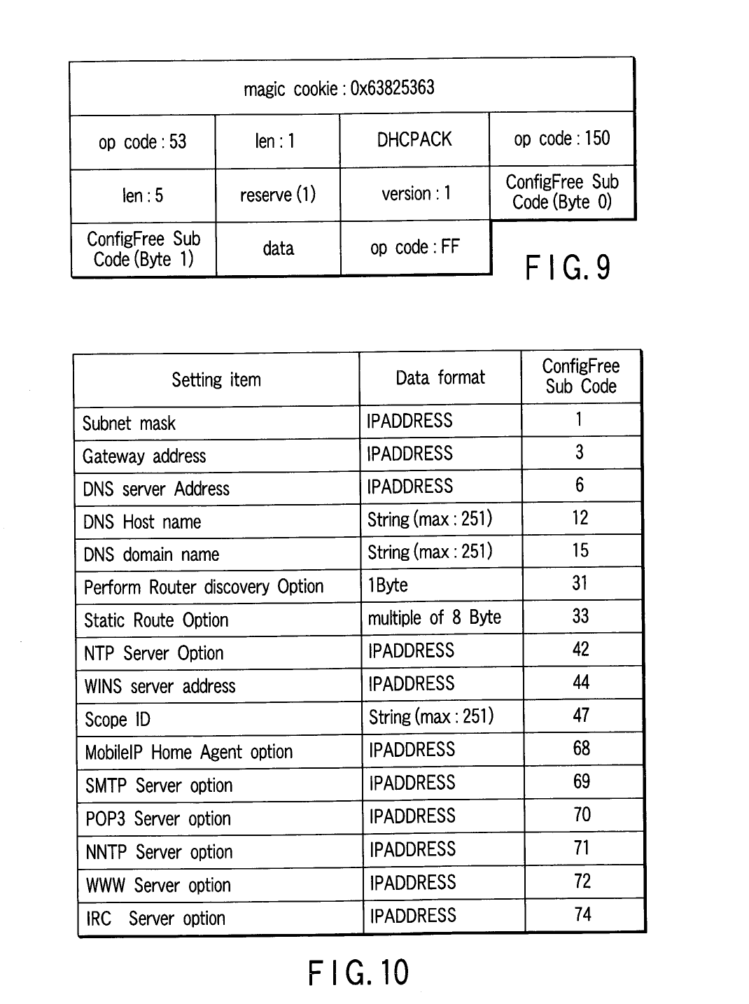

The second example is a setting information response message sent from the CF server to the CF client. FIG. 9 shows this example of the option field.

Three bytes starting from op code: 53 are an option representing the type of DHCP message. To send back setting information of the CF, DHCPACK (value: 5) is designated as the type.

Seven bytes starting from the next op code: 150 are an option representing a CF sub code. An identification number representing the type of setting information to be requested is designated in the CF Sub Code field. The setting information value is described in the data field.

The last 1 byte with a value 0xFF is an End option representing the end of an effective option.

CF Sub Code shown in FIG. 5 will be explained.

DHCP defines an option code for each transferred information, and cannot transmit types of information over 256 types of information which can be expressed by 1 byte assigned to an option code.

The purpose of the CF protocol is to transfer setting information sufficient to operate a network application. Therefore, 1-byte option codes may not be able to provide a satisfactory number of types of setting information along with an increase in network applications.

To prevent this, a sub code functioning as an option code is additionally nested in the data field of DHCP. This enables designating types of setting information over the 1-byte length of the data field of DHCP. In the embodiment of the CF protocol, the sub code length is given by 2 bytes.

FIGS. 10, 11, and 12 show examples of the sub code of the CF protocol.

FIG. 10 shows options usable as sub code options of the CF protocol out of DHCP option codes. In the CF protocol, these sub codes are assigned the same numbers as those of the DHCP option codes. The definition of a data field corresponding to each sub code is the same as that of a DHCP data field. Details of this are described in Chapter 3 in RFC 2132.

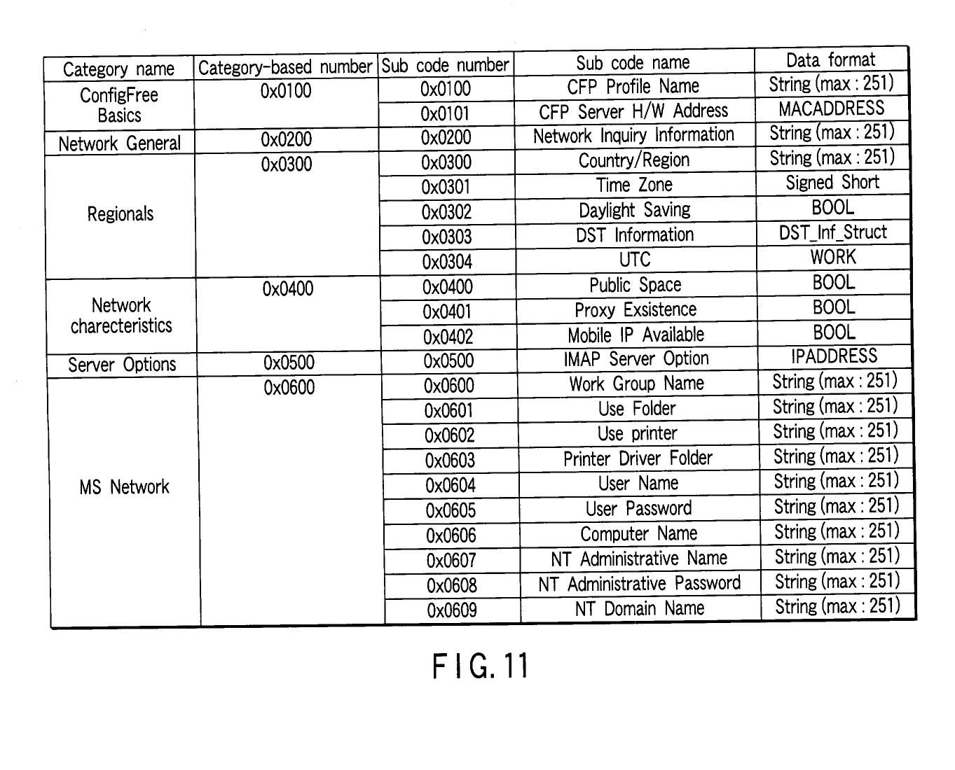

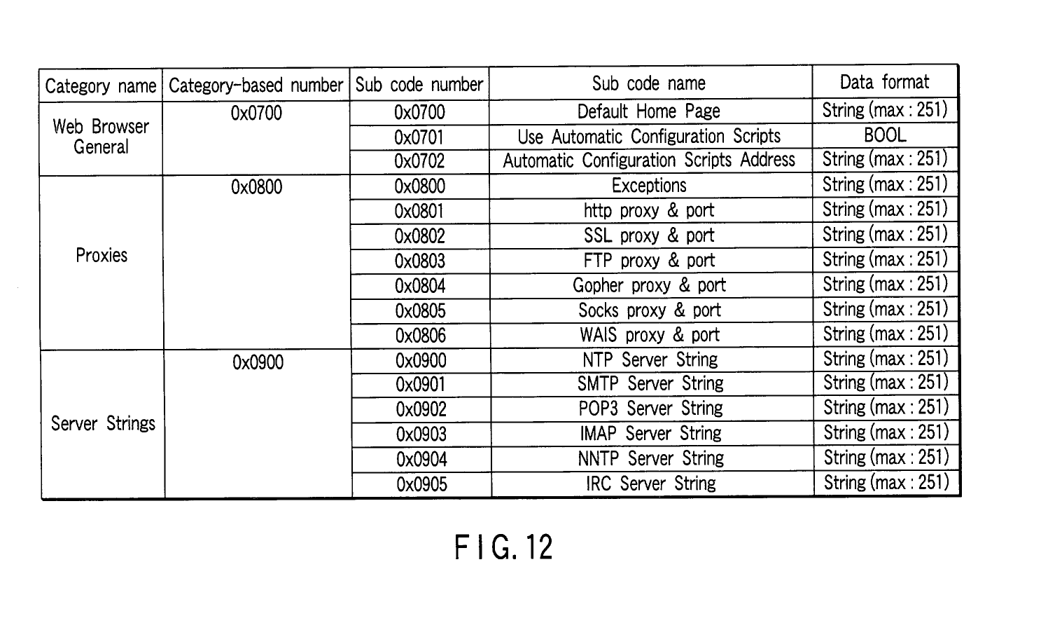

A category and category-based number in FIGS. 11 and 12 will be explained. The CF protocol gives a field length larger than 1 byte to a sub code number representing the type of information. If sub code numbers are assigned sequentially from 0 every time setting information is added, the sub code numbers and the types of information may become difficult to manage.

To prevent this, pieces of setting information are classified into several groups for respective applications or similar features, and the groups are identifiably assigned category names. A predetermined number of sub code numbers are assigned to each category in advance, and the start number of a sub code in each category is set as a category-based number.

Even added setting information to be grouped into a certain category can have a close sub code number. The reference relationship between the sub code number and setting information is improved. The category and category-based number are an example of the sub code number assignment method. Another assignment method of, e.g., simply sequentially assigning sub code numbers may be adopted.

The contents of each sub code shown in FIGS. 10 and 11 will be explained for each category. The following description is merely an example, and packaging different from the following one can be executed.

1. CF Basics

The category-based number (offset) is “0X0100”.

1.1. CFPProfile Name is used to exchange data representing setting information which can be provided by a CF server. A sub code number 0X0100 is stored in the CF Sub Code field, and an ASCII character string representing CF information provided by the CF server is stored in the data field. The minimum number of bytes is 5, and the maximum number of bytes is 255.

1.2. CFP Server H/W Address is used to exchange ID information uniquely representing the CF server. A sub code number 0X0101 is stored in the CF Sub Code field shown in FIG. 5, and ID information is stored in the data field.

In the embodiment of the present invention, only 6 bytes of the MAC address of an Ethernet address out of the MAC address of a network device are valid as ID information. The number of bytes is 10.

2. Network General

The category-based number (offset) is “0X0200”.

2.1. Network Inquiry Information is used to exchange, e.g., the location of the network manager who manages the CF server. A sub code number 0X0200 is stored in the CF Sub Code field. An ASCII character string which represents the location of the network manager who manages the CF server and contains a NULL terminal character is stored in the data field. The minimum number of bytes is 5, and the maximum number of bytes is 255.

3. Regionals

The category-based number (offset) is “0X0300”.

3.1. Country/Region is used to exchange information representing a country or region where the CF server is located. A sub code number 0X0300 is stored in the CF Sub Code field. An ASCII character string representing the country or region where the CF server is located is stored in the data field. The minimum number of bytes is 5, and the maximum number of bytes is 255.

3.2. Time Zone is used to exchange information representing by signed minutes the GMT offset of the region where the CF server is located. A sub code number 0X0301 is stored in the CF Sub Code field. Information representing by signed minutes the GMT offset of the region where the CF server is located is stored in the data field. The number of bytes is 6.

3.3. Daylight Saving is used to exchange information representing whether the summer time of the region where the CF server is located is valid or invalid. A sub code number 0X0302 is stored in the CF Sub Code field. “0” or “1” representing whether the summer time of the region where the CF server is located is valid or invalid is stored in the data field. The number of bytes is 5.

3.4. DST Info is used to exchange information representing summer time information of the region where the CF server is located. A sub code number 0X0303 is stored in the CF Sub Code field. Summer time information of the region where the CF server is located is stored in the data field. The number of bytes is 28 or 24.

3.5. UTC is used to exchange information representing the current UTC (Coordinated Universal Time) value. A sub code number 0X0304 is stored in the CF Sub Code field. Information representing the current UTC (Coordinated Universal Time) value is stored in the data field. The number of bytes is 8.

4. Network Characteristics

The category-based number (offset) is “0X0400”.

4.1. Public Space is used to exchange information representing whether the place where the CF server is located is a public space. A sub code number 0X0400 is stored in the CF Sub Code field. “0” or “1” representing whether the place where the CF server is located is a public space is stored in the data field. The number of bytes is 5.

4.2. Proxy Existence is used to exchange information representing whether the proxy needs to be used to access the Internet from a connected network. A sub code number 0X0401 is stored in the CF Sub Code field. Information “0” or “1” representing whether the proxy needs to be used to access the Internet from a connected network is stored in the data field. The number of bytes is 5.

4.3. Mobile IP Available is used to exchange information representing whether the Mobile IP function can be used from a connected network. A sub code number 0X0402 is stored in the CF Sub Code field. Information “0” or “1” representing whether the Mobile IP function can be used from a connected network is stored in the data field. The number of bytes is 5.

5. Server Options

The category-based number (offset) is “0X0500”.

5.1. IMAP Server is used to exchange information representing a list of the addresses of usable IMAP servers. A sub code number 0X0500 is stored in the CF Sub Code field. Information representing a list of the addresses of usable IMAP servers is stored in the data field. The minimum number of bytes is 8, and the maximum number of bytes is 2.

6. MS Network

The category-based number (offset) is “0X0600”.

6.1. Work Group Name is used to exchange information representing the work group name of Microsoft Network. A sub code number 0X0600 is stored in the CF Sub Code field. An ASCII character string which represents the work group name of Microsoft Network and contains a NULL terminal character is stored in the data field. The minimum number of bytes is 5, and the maximum number of bytes is 255.

6.2. Use Folder is used to exchange information which contains a NULL terminal character string provided by a subnet and represents the path of a common file in Microsoft Network. A sub code number 0X0601 is stored in the CF Sub Code field. An ASCII character string which contains a NULL terminal character string provided by the subnet and represents the path of a common file in Microsoft Network is stored in the data field. The minimum number of bytes is 5, and the maximum number of bytes is 255.

6.3. Use Printer is used to exchange information which contains a NULL terminal character string provided by the subnet and represents the path of a common printer in Microsoft Network. A sub code number 0X0602 is stored in the CF Sub Code field. An ASCII character string which contains a NULL terminal character string provided by the subnet and represents the path of a common printer in Microsoft Network is stored in the data field. The minimum number of bytes is 5, and the maximum number of bytes is 255.

6.4. Printer Driver Folder is used to exchange information representing the name of a network folder that stores a Use Printer driver. A sub code number 0X0603 is stored in the CF Sub Code field. An ASCII character string which represents the name of a network folder that stores a Use Printer driver and contains a NULL terminal character string is stored in the data field. The subfolders of this folder are assumed to store a printer driver for each OS and a printer driver installed package, but details of them are not defined in the CF protocol. The minimum number of bytes is 1, and the maximum number of bytes is 255.

6.5. User Name is used to exchange information representing a user name granted to access a Microsoft Network resource running on the subnet. A sub code number 0X0604 is stored in the CF Sub Code field. An ASCII character string which represents the user name granted to access a Microsoft Network resource running on the subnet and contains a NULL terminal character string is stored in the data field. The minimum number of bytes is 5, and the maximum number of bytes is 255.

6.6. User Password is used to exchange information representing the password of CF Sub code No. 260 User Name. A sub code number 0X0605 is stored in the CF Sub Code field. An ASCII character string which represents the password of CF Sub code No. 260 User Name and contains a NULL terminal character string is stored in the data field. In the absence of any password, the length of the character string is 4. The minimum number of bytes is 4, and the maximum number of bytes is 255.

6.7. Computer Name is used to exchange information representing a host computer name in the MS network. A sub code number 0X0606 is stored in the CF Sub Code field. An ASCII character string which represents a host computer name in the MS network and contains a NULL terminal character string is stored in the data field. The minimum number of bytes is 4, and the maximum number of bytes is 255.

6.8. NT Administrative Name is used to exchange information representing an account name having the Administrator authority of CF Sub Code No. 0X0609 NT Domain. A sub code number 0X0606 is stored in the CF Sub Code field, and a sub code number 0X0607 is stored in the data field. An ASCII character string which represents an account name having the Administrator authority of CF Sub Code No. 0X0609 NT Domain and contains a NULL terminal character string is stored in the data field. The minimum number of bytes is 5, and the maximum number of bytes is 255.

6.9. NT Administrative Password is used to exchange information representing the password of an account designated by CF Sub Code No. 0X0607 Administrative Name. A sub code number 0X0608 is stored in the CF Sub Code field. An ASCII character string which represents the password of an account designated by CF Sub Code No. 0X0607 Administrative Name and contains a NULL terminal character string is stored in the data field. In the absence of any password, the length of the character string is 4. The minimum number of bytes is 4, and the maximum number of bytes is 255.

6.10. NT Domain Name is used to exchange information representing the name of an NT domain where the CF server operates or representing an NT domain expected to connect a client. A sub code number 0X0609 is stored in the CF Sub Code field. An ASCII character string which represents the name of an NT domain where the CF server operates or representing an NT domain expected to connect a client, and contains a NULL terminal character is stored in the data field. The minimum number of bytes is 4, and the maximum number of bytes is 255.

7. Web Browser General

The category-based number (offset) is “0X0700”.

7.1. Default Home Page is used to exchange information representing the address of the default homepage of a Web browser. A sub code number 0X0700 is stored in the CF Sub Code field. An ASCII character string which represents the address of the default homepage of a Web browser and contains a NULL terminal character is stored in the data field. The minimum number of bytes is 5, and the maximum number of bytes is 255.

7.2. Use Automatic Configuration Scripts is used to exchange information representing whether to validate the automatic script of Internet connection LAN setting serving as a Microsoft Internet Explorer option. A sub code number 0X0701 is stored in the CF Sub Code field. Information “0” or “1” representing whether to validate the automatic script of Internet connection LAN setting serving as a Microsoft Internet Explorer option is stored in the data field. The number of bytes is 5.

7.3. Automatic Configuration Scripts Address is used to exchange information representing the network address of the automatic script file of Internet connection LAN setting serving as a Microsoft Internet Explorer option. A sub code number 0X0702 is stored in the CF Sub Code field. An ASCII character string which represents the network address of the automatic script file of Internet connection LAN setting serving as a Microsoft Internet Explorer option and contains a NULL terminal character is stored in the data field. The minimum number of bytes is 5, and the maximum number of bytes is 255.

8. Proxies

The category-based number (offset) is “0X0800”.

8.1. Exceptions is used to exchange information representing network information not using any proxy in Web browser setting. A sub code number 0X0800 is stored in the CF Sub Code field. An ASCII character string which represents network information not using any proxy in Web browser setting and contains a NULL terminal character is stored in the data field. The minimum number of bytes is 5, and the maximum number of bytes is 255.

8.2. Http proxy & port is used to exchange information representing an http proxy name for setting a Web browser. A sub code number 0X0801 is stored in the CF Sub Code field. An ASCII character string which represents an http proxy name for setting a Web browser and contains a NULL terminal character is stored in the data field. The minimum number of bytes is 5, and the maximum number of bytes is 255.

8.3. SSL proxy & port is used to exchange information representing a secure proxy name for setting a Web browser. A sub code number 0X0802 is stored in the CF Sub Code field. An ASCII character string which represents a secure proxy name for setting a Web browser and contains a NULL terminal character is stored in the data field. The minimum number of bytes is 5, and the maximum number of bytes is 255.

8.4. FTP proxy & port is used to exchange information representing an FTP proxy name for setting a Web browser. A sub code number 0X0803 is stored in the CF Sub Code field. An ASCII character string which represents an FTP proxy name for setting a Web browser and contains a NULL terminal character is stored in the data field. The minimum number of bytes is 5, and the maximum number of bytes is 255.

8.5. Gopher proxy & port is used to exchange information representing a Gopher proxy name for setting a Web browser. A sub code number 0X0804 is stored in the CF Sub Code field. An ASCII character string which represents a Gopher proxy name for setting a Web browser and contains a NULL terminal character is stored in the data field. The minimum number of bytes is 5, and the maximum number of bytes is 255.

8.6. Socks proxy & port is used to exchange information representing a Socks proxy name for setting a Web browser. A sub code number 0X0805 is stored in the CF Sub Code field. An ASCII character string which represents a Socks proxy name for setting a Web browser and contains a NULL terminal character is stored in the data field. The minimum number of bytes is 5, and the maximum number of bytes is 255.

8.7. WAIS proxy & port is used to exchange information representing a WAIS proxy name for setting a Web browser. A sub code number 0X0806 is stored in the CF Sub Code field. An ASCII character string which represents a WAIS proxy name for setting a Web browser and contains a NULL terminal character is stored in the data field. The minimum number of bytes is 5, and the maximum number of bytes is 255.

9. Server Strings

The category-based number (offset) is “0X0900”.

9.1. NTP Server String is used to exchange information representing the host name of an NTP (Network Time Protocol) server. A sub code number 0X0900 is stored in the CF Sub Code field. An ASCII character string which represents the host name of the NTP (Network Time Protocol) server and contains a NULL terminal character is stored in the data field. The minimum number of bytes is 5, and the maximum number of bytes is 255.

9.2. SMTP Server String is used to exchange information representing the host name of an SMTP (Simple Mail Transfer Protocol) server. A sub code number 0X0901 is stored in the CF Sub Code field. An ASCII character string which represents the host name of the SMTP (Simple Mail Transfer Protocol) server and contains a NULL terminal character is stored in the data field. The minimum number of bytes is 5, and the maximum number of bytes is 255. FIG. 12 shows a case in which the option field is SMTP Server String.

9.3. POP3 Server String is used to exchange information representing the host name of a POP (Post Office Protocol) 3 server. A sub code number 0X0902 is stored in the CF Sub Code field. An ASCII character string which represents the host name of the POP (Post Office Protocol) 3 server and contains a NULL terminal character is stored in the data field. The minimum number of bytes is 5, and the maximum number of bytes is 255.

9.4. IMAP Server String is used to exchange information representing the host name of an IMAP (Internet Message Access Protocol) server. A sub code number 0X0903 is stored in the CF Sub Code field. An ASCII character string which represents the host name of the IMAP (Internet Message Access Protocol) server and contains a NULL terminal character is stored in the data field. The minimum number of bytes is 5, and the maximum number of bytes is 255.

9.5. NTTP Server String is used to exchange information representing the host name of an NTTP (Network News Transfer Protocol) server. A sub code number 0X0904 is stored in the CF Sub Code field. An ASCII character string which represents the host name of the NTTP (Network News Transfer Protocol) server and contains a NULL terminal character is stored in the data field. The minimum number of bytes is 5, and the maximum number of bytes is 255.

9.6. IRC Server String is used to exchange information representing the host name of an IRC (Internet Relay Chat) server. A sub code number 0X0905 is stored in the CF Sub Code field. An ASCII character string which represents the host name of the IRC (Internet Relay Chat) server and contains a NULL terminal character is stored in the data field. The minimum number of bytes is 5, and the maximum number of bytes is 255.

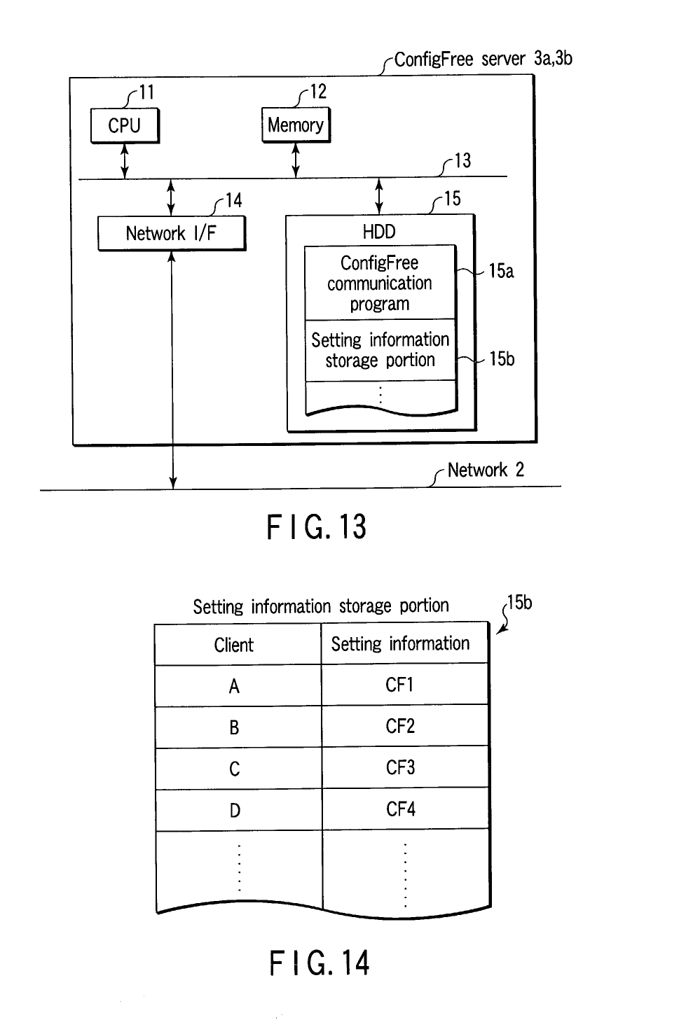

FIG. 13 is a block diagram showing the arrangement of the CF servers 3a and 3b.

As shown in FIG. 13, each of the CF servers 3a and 3b comprises a CPU 11, memory 12, bus 13, network I/F 14, and HDD (Hard Disk Drive) 15. The CPU 11, memory 12, network I/F 14, and HDD 15 are connected to the bus 13.

The HDD 15 has a CF communication program 15a, and a setting information storage portion 15b for storing setting information used in a network application program.

The CPU 11 controls the CF servers 3a and 3b, and executes the CF communication program 15a and the like.

The memory 12 is a work memory for the CPU 11.

The network I/F 14 is an interface between the network 2 and the CF servers 3a and 3b.

The CF communication program 15a uses the CF protocol according to the embodiment of the present invention, and communicates setting information used in a network application program.

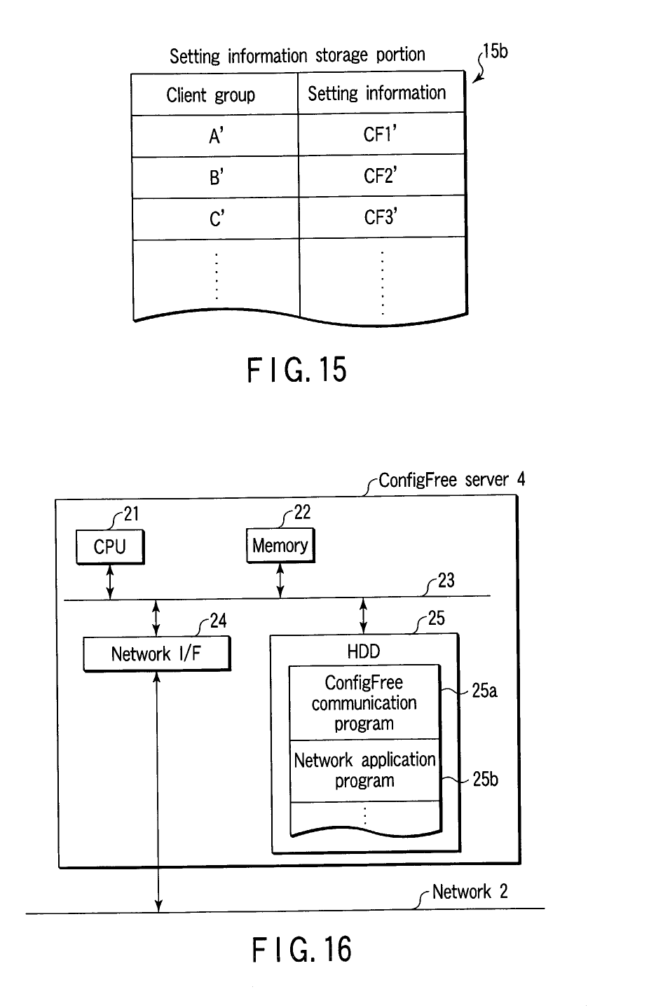

The setting information storage portion stores setting information used in a network application program. The setting information is stored for each client, as shown in FIG. 14. The setting information storage format is not limited to the one shown in FIG. 14. Setting information may be stored for each client group, as shown in FIG. 15.

A client is identified by setting a 6-byte CF client identifier field before the Sub Code field, and containing the MAC address of a CF client in the identifier field of the CF client. A CF server which receives a CF request message can uniquely identify the CF request message transmission source.

Since the CF server holds setting information for each CF client, it can supply more appropriate setting information to each CF client. More specifically, the user name of Microsoft Network transferred for each CF client can be changed, or the address of the IMAP server can be changed.

In terms of management of a network where the CF server is installed, the security can be controlled such that the access authority to the network can be changed.

FIG. 16 is a block diagram showing the arrangement of the CF client 4.

As shown in FIG. 16, the CF client 4 comprises a CPU 21, memory 22, bus 23, network I/F 24, and HDD 25. The CPU 21, memory 22, network I/F 24, and HDD 25 are connected to the bus 23.

The HDD 25 has a CF communication program 25a and network application program 25b.

The CPU 21 controls the CF client 4, and executes the CF communication program 25a and the like.

The memory 22 is a work memory for the CPU 21.

The network I/F 24 is an interface between the network 2 and the client 4.

The CF communication program 25a uses the CF protocol according to the embodiment of the present invention, and communicates setting information used in a network application program.

The network application program 25b is a program which runs on the basis of setting information that is transmitted by the CF server and received by the CF communication program.

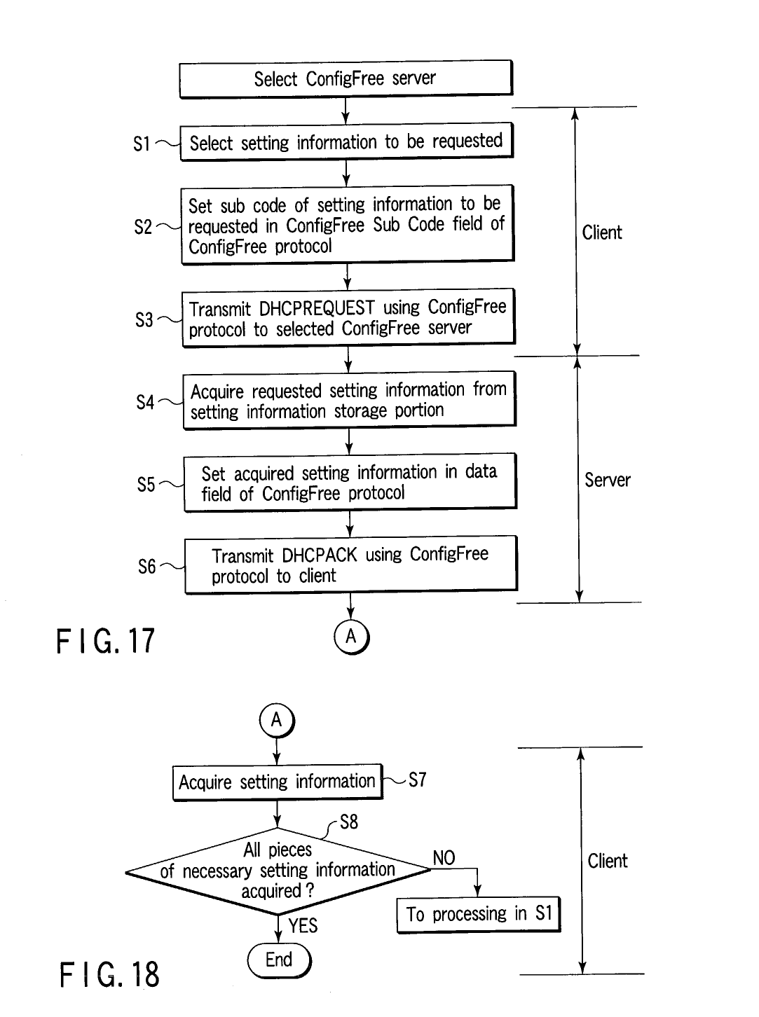

The operation of the wireless communication system according to the embodiment of the present invention will be explained with reference to the flow chart of FIG. 17.

An operation up to output of a DHCPDISCOVER message from a client and selection of a server is the same as the operation using the conventional DHCP, and a description thereof will be omitted.

Setting information requested to use a network application program in the client is selected (S1). The sub code of the requested setting information is set in the CF Sub Code field of the CF protocol (S2).

DHCPREQUEST which holds the sub code of the setting information and uses the CF protocol is transmitted to the selected CF server (S3).

The CF server acquires the setting information requested by the client from the setting information storage portion of the HDD (S4). When the setting information storage portion stores setting information in a format as shown in FIG. 14, the requested setting information is acquired from setting information corresponding to the requesting client. When the setting information storage portion stores setting information in a format as shown in FIG. 15, the requested setting information is acquired from setting information corresponding to a group to which the requesting client belongs.

The server sets the acquired setting information in the data field of the CF protocol (S5), and transmits, to the client, DHCPACK which holds the setting information and uses the CF protocol (S6).

The client acquires the setting information contained in DHCPACK transmitted from the server (S7), and checks whether the client has acquired all pieces of necessary setting information (S8).

If NO in S8, the flow returns to processing in S1; if YES, setting information acquisition processing ends. The acquired setting information is used as setting information of a network application program.

The use of the DHCP protocol cannot fully designate information required in a network application program. To the contrary, the wireless communication system of the embodiment can satisfactorily designate information required in a network application program by using the CF protocol.

For example, setting information may contain information about the location of the network manager. In this case, the network terminal user can know the location of the network manager when a problem occurs in connecting a network terminal.

Setting information may contain information representing a country or region where a setting information server exists. The display of the time, date, currency, language, and figure of an application or operation system can be optimized.

Setting information may contain time information of the region where the setting information server exists. The time setting of an application or operating system can be optimized.

Setting information may contain information representing whether the place where the setting information server is located is a public space. The security level of an application or operating system in network connection can be optimized. This information can be used to determine whether to use a VPN application.

Setting information may contain information representing whether to use a proxy server in order to connect a network terminal to an external network. In this case, when the network terminal can be connected to an external network such as the Internet without using any proxy server, information about a plurality of types of possible proxy servers need not be requested from the network terminal.

Setting information may contain information representing whether the Mobile IP function can be used in a network where the setting information server is located. In this case, even if Mobile IP Home Agent information is distributed by DHCP, the network router may restrict the use of the Mobile IP. Whether to use a Mobile IP application can be determined.

Setting information may contain address information of a usable IMAP server. DHCP transfers address information of a POP server, but does not transfer address information of an IMAP server. Transferring address information of the IMAP server enables automatically setting a mail access by the IMAP server.

When setting information contains information representing information about Microsoft Network, the network terminal can acquire a work group name, user name, shared folder name, and the like. Various services provided by Microsoft Network can be utilized without manual setting.

When setting information contains information representing information about a Web browser, the network terminal can acquire a default homepage address, various proxy server addresses, and the like which are set in the Web browser. The network terminal can access the Internet via the Web browser without manual setting.

When setting information is managed for each network terminal, more proper setting information can be transferred for each network terminal.

When setting information is managed for each network terminal group, a plurality of network terminals which appropriately receive the same setting information are grouped into one. This can decrease the burden of information management on the setting information server side.

The present invention is not limited to the above-described embodiment, and can be variously modified without departing from the spirit and scope of the invention in practical use. The embodiment includes inventions on various stages, and various inventions can be extracted by an appropriate combination of building components disclosed. For example, when an invention is extracted by omitting several building components from all those described in the embodiment, the omission is properly compensated for by a well-known technique in practicing the extracted invention.

As has been described in detail above, the present invention can provide a wireless communication system capable of transferring setting information such that the user who carries a network terminal with him/her and tries to connect the network terminal to different networks can connect the network terminal to a network without manually changing settings and utilize a network application.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication system comprising:
a server having a storage portion which stores setting information of a network application program running on a network terminal; and
a client configured to communicate with said server via a network and outputs a setting information request for requesting the setting information to said server,
wherein the setting information request contains a first field which stores an identification number representing a type of the setting information and a second field which stores the setting information, and
said server sets, in the second field, setting information corresponding to the identification number contained in the first field of the setting information request from said client, and outputs the setting information set in the second field to said client.

2. The system according to claim 1, wherein a size of the first field is more than 2 bytes.

3. The system according to claim 1, wherein the setting information request further comprises a third field which stores version information of a protocol which communicates between the server and the client.

4. The system according to claim 1, wherein the setting information includes information representing a country and region to which said server belongs.

5. The system according to claim 1, wherein the setting information includes time information of a region where said client exists.

6. The system according to claim 1, wherein the setting information includes information representing whether to use a proxy server for connecting said client to an external network.

7. The system according to claim 1, wherein the setting information includes information representing whether a Mobile IP function can be used in the network.

8. The system according to claim 1, wherein the setting information includes address information of a usable IMAP server.

9. The system according to claim 1, wherein the setting information includes information about a default homepage address of a web browser.

10. The system according to claim 1, wherein said server stores the setting information for each client.

11. The system according to claim 1, wherein said server stores the setting information for each group of clients.

12. A setting information acquisition method comprising:
outputting from a client to a server a setting information request complying with a predetermined protocol which requests setting information of a network application program running on a network terminal;
outputting requested information from the server to the client in accordance with the predetermined protocol on the basis of the setting information request; and
receiving by the client the requested setting information output from the server,
wherein the predetermined protocol contains a first field which stores an identification number representing a type of setting information, and a second field which stores the setting information, and
the server sets, in the second field, setting information corresponding to the identification number stored in the first field, and outputs the setting information set in the second field to the client by using the predetermined protocol.

13. The method according to claim 12, wherein a size of the first field is more than 2 bytes.

14. The method according to claim 12, wherein the setting information includes time information of a region where said client exists.

15. The method according to claim 12, wherein the setting information includes information representing whether to use a proxy server for connecting said client to an external network.

16. The method according to claim 12, wherein the setting information includes information about a default homepage address of a web browser.
